(19) United States
(12) Patent Application Publication
(10) Pub. No.: US 2004/0057656 A1
(43) Pub. Date: Mar. 25, 2004

(54) Double Risley prism pairs for optical beam steering and alignment

(75) Inventors: Charles Chu, Irvine, CA (US); Tsu-Chin Tsao, Manhattan Beach, CA (US); Jingyu Zhou, Irvine, CA (US); Michael Young, Irvine, CA (US)

Correspondence Address: DiPINTO & SHIMOKAJI, P.C., Suite 480, 1301 Dove Street, NewPort Beach, CA, 92660, US

(73) Assignee: Advanced Optical MEMS, Inc., Irvine, CA (US)

(21) Appl. No.: 10/393,907

(22) Filed: Mar. 20, 2003

Related U.S. Application Data
(60) Provisional application No. 60/413,282, filed on Sep. 24, 2002.

(51) Int. Cl. G02B 6/35; G02B 6/34

(52) U.S. Cl. 385/17; 385/36

(57) ABSTRACT

An optical communication system includes an input optical fiber, an output optical fiber, and first and second Risley prism pairs disposed in an optical path between the input optical fiber and the output optical fiber. A first actuator is configured to independently rotate a first and a second prism of the first Risley prism pair so that a first light beam is steered to be incident on the second Risley prism pair by adjusting the first Risley prism pair. A second actuator is configured to independently rotate a third and a fourth prism of the second Risley prism pair so that a second light beam is steered to be incident on the first Risley prism pair by adjusting the second Risley prism pair, providing optical beam alignment of the optical path for communication and optical switching.

### CROSS REFERENCE TO RELATED APPLICATIONS

This application claims the benefit of U.S. Provisional Application No. 60/413,282, filed Sep. 24, 2002.

### BACKGROUND OF THE INVENTION

The present invention generally relates to fiber optic communications and, more particularly, to using double Risley prism pairs for optical beam alignment in a 3-dimensional, all-optical, fiber optical switch and also in free space optical communication.

Fiber optical switches find wide application in communications. Fiber optical switches are increasingly used in the telecommunications industry, where fiber optical switches may be used, for example, in a central office core router of a telecommunications network as cross-connect switches for metro and long haul services.

FIG. 1A shows an optical communication system hierarchy 100 according to the prior art, including long haul and metro telecommunications switching networks, for example, long haul switching network 102 and metro telecommunications switching networks 104 and 106. Optical communication system hierarchy 100 may include nodes—such as nodes 108—that communicate using optical communication links—such as links 110—between the nodes, typically connected in loops. Optical fibers may be used in the links—such as links 110—as working, protection, add, or drop links, as known in the art, for transmitting signal light beams between nodes—such as nodes 108. A node may be, for example, a telephone exchange, such as public switched telephone network (PSTN) 112 or cellular network 114, shown in FIG. 1A connected, for example, by a synchronous optical network (SONET) network 116. As seen in FIG. 1A, for example, metro telecommunications switching network 104 may be connected via one or more optical links—such as optical links 117—to residential extended digital subscriber line (x-DSL) network 118. Also as seen in FIG. 1A, for example, metro telecommunications switching network 106 may be connected via one or more optical links—such as optical links 119—to internet protocol (IP) router 120, connecting asynchronous transfer mode (ATM) switch 122 and Ethernet local area network (LAN) 124 for a regional internet service provider (ISP). Also as seen in FIG. 1A, for example, metro telecommunications switching network 106 may be connected via one or more optical links—such as optical links 125—to a corporate enterprise systems connection (ESCON) network 126, which may comprise a frame relay ESCON fiber channel network or gigabit Ethernet, as known in the art. Each of PSTN 112, cellular network 114, SONET network 116, residential x-DSL network 118, IP router 120, ATM switch 122, Ethernet LAN 124, and ESCON network 126 may connected through an optical cross connect switch to a switching network—such as metro telecommunications switching networks 104 and 106.

Referring now to FIG. 1B, an example of a long haul switching network 130 is illustrated. Long haul switching network 130 may correspond, for example, to long haul switching network 102, shown in optical communication system hierarchy 100 of FIG. 1A. Long haul switching network 130 may include nodes—such as nodes 108—that communicate using optical fiber links—such as links 110—between the nodes. Links—such as links 110—typically connect the nodes—such as nodes 108—in loops. For example, nodes 132, 134, and 136 are shown in FIG. 1B connected in a loop by links 131, 133, and 135. Link 131 connects node 136 with node 132; link 133 connects node 132 with node 134, and link 135 (shown as a broken link) would ordinarily connect node 134 with node 136. Links—such as links 131, 133, and 135—may comprise multiple optical fibers that may be used as working, protection, add, or drop fibers, in any combination, as known in the art, for transmitting signal light beams between nodes—such as nodes 132, 134, and 136. For example, communication between node 136 and node 134 would ordinarily be transmitted over working fibers of link 135. If link 135 should become disabled, illustrated in FIG. 1B by a break in link 135, communication can be rerouted for example, over links 131 and 133 between node 136 and node 134 via node 132, using protection fibers included in links 131 and 133. Such rerouting can be accomplished, as known in the art, by means of optical cross connect switches or protection switches, which may be optical cross connect switches configured to perform such rerouting.

Referring now to FIG. 1C, examples of several types of connections to a metro telecommunications switching network 140 is illustrated. Metro telecommunications switching network 140 may correspond, for example, to metro telecommunications switching network 104 or metro telecommunications switching network 106, shown in optical communication system hierarchy 100 of FIG. 1A. Metro telecommunications switching network 140 may include nodes—such as nodes 142, 144, 146, and 148—connected in a loop by links 141, 143, 145, and 147, where link 141 connects node 148 with node 142; link 143 connects node 142 with node 144, and so forth, as shown in FIG. 1C. Links—such as links 141, 143, 145, and 147—may comprise multiple optical fibers that may be used as working, protection, add, or drop fibers, in any combination, as known in the art, for transmitting signal light beams between nodes—such as nodes 142, 144,146, and 148. Each of nodes 142, 144, 146, and 148—as well as nodes 108, shown in FIGS. 1A, 1B, and 1C, may comprise one or more optical cross connect switches. Each cross-connect switch may be configured to act as a non-blocking cross-connect switch, protection switch, add/drop module, or mux/demux, as known in the art.

Individual clients, are typically connected into a metro telecommunications switching network—such as metro telecommunications switching network 140—using an add/drop module. For example, add/drop module 150 may be used, as known in the art and shown in FIG. 1C, to connect LAN 152, ATM switch 154, and access router 156 to node 142 of metro telecommunications switching network 140. Also, for example, mux/demux 158 may be used, as known in the art and shown in FIG. 1C, to connect SONET add/drop multiplexer (ADM) 160, ESCON node 162, and enterprise frame relay router 164 to node 109 of metro telecommunications switching network 140. Also, for example, SONET distributed communication system (DCS) 166 may be connected, as known in the art and shown in FIG. 1C, to node 144 of metro telecommunications switching network 140. Each node—such as node 144—of metro telecommunications switching network 140 may appropriately route the signals connected to the node using optical cross-connect switches included in the node and configured—for example, as non-blocking cross-connect switch, protection switch, add/drop module, or mux/demux—to perform the appropriate function. Thus, the cross-connect switch has come to be a fundamental component of telecommunication systems.

An optical cross-connect switch may allow light to be routed between optical fibers in such a way that any optical fiber from one side of the switch can be optically connected to any of the optical fibers on another side of the switch. Metro and long haul services may be provided using dense wavelength division multiplexing (WDM or DWDM). DWDM is a technology that uses multiple lasers and transmits several wavelengths of light simultaneously over a single optical fiber. Each signal travels within its unique color band, which is modulated by the data (text, voice, video, for example). DWDM enables the existing fiber infrastructure of the telephone companies and other carriers to be dramatically increased. DWDM systems exist that can support more than 150 wavelengths. Such systems can provide more than 1,000 giga-bits per second (Gbps or billion bits per second) of data transmission on one optical fiber. Several key components in optical communications networks—including optical add/drop modules (OADM), protection switches, and cross-connect switches—may be implemented using optical switches

Conventional fiber optical switches that connect optical fiber lines are electro-optical. Such conventional switches convert photons from the input side to electrons internally in order to do the signal switching electronically and then convert back to photons on the output side, thus being referred to as optical-electrical-optical (OEO) switches. By way of contrast, an all-optical fiber optical switch, referred to as optical-optical-optical (OOO), is a switching device that maintains the signal as light from input to output. Although some vendors call electro-optical switches “optical switches,” true optical switches, i.e., all-optical switches, support all transmission speeds. Unlike electronic switches, which are tied to specific data rates and protocols, all-optical, or OOO, switches direct the incoming data bit stream to the output port no matter what the line speed or protocol (such as IP, ATM, or SONET) and do not have to be upgraded for any changes to the protocol.

An optical switch is a device that can be used to switch a small and collimated beam of light in free space by either leaving the light path to pass through a location unaffected or changing the light path to a different direction at the location. The switching can be done mechanically, for example, by moving a mirror between two distinct and stable positions—in the path of the light, and out of the path of the light. Switching by changing a light path between two distinct and stable positions may be referred to as digital switching. Digital switching is usually implemented by a switch in which the ends of all of the optical fibers connected to the switch are in the same plane, referred to as being 2-dimensional.

For example, a 2-dimensional optical cross-connect switch can be implemented with a planar array of mirrors that can be moved into and out of the path of the light for switching light beams between optical fibers. Switching can also be done mechanically, for example, by moving an optical element, such as a lens, prism, or mirror, continuously from one position to another in order to redirect a light path from one destination to another, which may be referred to as analog switching. Because the optical element is continuously adjustable in analog switching, the geometrical configuration in which optical fibers are connected to the switch is less constrained. For example, the ends of all of the optical fibers connected to the analog switch need not be in the same plane, so that the analog switch may be referred to as being 3-dimensional.

Recently, attempts have been made to use Risley prism pairs for optical switching. Risley prisms are known from their application to other technologies, as disclosed, for example, in U.S. Pat. No. 6,343,767, issued Feb. 5, 2002 to Sparrold, et al., where the use of Risley prism pairs in a missile seeker is disclosed. U.S. Pat. No. 2001/0,046,345 A1, published Nov. 29, 2001 by Snyder et al. discloses the use of Risley prism pairs for use in 3-dimensional analog optical switches. As disclosed in Snyder et al., optical switching uses one Risley prism pair for beam steering from an input fiber to one of many output fibers. For multiple input, multiple output optical switches, which may be referred to as M×N switches, where M is the number of input fibers and N is the number of output fibers, the beams must not only be steered to “shoot at” a certain location where the output fiber is located but must also be aligned to the output fiber's incident angle.

When using only one Risley prism pair for the beam steering, the output fiber may be mechanically oriented, for example, to an angle optically aligned to the steered incoming beam. Collimating and focusing lenses may also be used, for example, in the light path of the steered beam to perform the beam alignment not provided by the single Risley prism pair. In multiple input, multiple output switches, however, as the number of output fibers increases, the optical angle of the Risley prism pair, i.e., the range of different angles through which the Risley prism pair can steer a beam of light, must be increased. The increasing optical angle, however, works against the requirement for alignment to the output fiber's incident angle. In other words, an output fiber adequately aligned to receive light from one Risley prism pair may not be able to receive light from a different Risley prism pair in the switch, thus limiting the number of inputs and outputs that are practical for a given Risley prism pair optical angle. Snyder et al. disclose a Risley prism pair optical angle of a typical value of 1.1 degree of arc. Therefore, the prior art beam steering suffers from serious drawbacks that make it only suitable for 1×N switching rather than the M×N switching needed for cross-connect switch applications.

Furthermore, there are recent developments in free space optics, where optical communication is between two locations, such as buildings, with line of sight being accomplished by laser beam steering using tilting mirrors or mechanical gimbals mechanisms. FIG. 1D shows an example of a free space optical communication system 170. Optical communication system 170 may comprise, for example, a laser communication (lasercom) terminal 172 (a first node in the above terminology) that communicates over optical communication link 173, i.e., using a communication light beam, with a second lasercom terminal 174 (a second node). Although, the example illustrates optical communication system 170 used to communicate between two buildings 175 and 177, lasercom terminals 172 and 174 of optical communication system 170 may comprise a satellite lasercom terminal 176, or a ground lasercom terminal 178, as also shown in FIG. 1D, for communication between the earth and a satellite in orbit, for example. For optical beam steering in free space optical communication, a tilting mirror or gimbals mechanism approach is typically used to steer the communication light beams—such as the communication light beam comprising link 173. Risley prism pairs can also be employed for the same beam steering function achieved presently by tilting mirrors. The optical alignment is less sensitive to mechanical angle variations of the Risley prisms than the tilting mirrors. The same problems of optical beam alignment alluded to above, however, still arise, i.e., the beams must not only be steered to “shoot at” a certain location where an output fiber of a lasercom terminal is located but must also be aligned to the output fiber's incident angle.

As can be seen, there is a need for optical beam steering and alignment in optical communication systems—such as optical switching networks and free space optical communication systems—that quickly and reliably achieve accurate optical beam alignment. Furthermore, there is a need for optical beam steering and alignment in an analog optical switch that achieves accurate alignment regardless of the number of input and output fibers. Also, there is a need in optical communication systems for optical beam steering and alignment that achieves a larger Risley prism pair optical angle.

### SUMMARY OF THE INVENTION

In one aspect of the present invention, an optical communication apparatus comprises an input optical fiber that transmits a first light beam; an output optical fiber that transmits a second light beam; a first Risley prism pair disposed in an optical path between the input optical fiber and the output optical fiber; and a second Risley prism pair disposed in the optical path between the first Risley prism pair and the output optical fiber. The first Risley prism pair, which is located on the input optical fiber side, steers the light beam from the input optical fiber and makes it incident on the second Risley prism pair, which is located on the output optical fiber side. The second Risley prism pair steers the incident light beam angle to align it with the incident angle of the output optical fiber, thereby forming an aligned optical path between the input optical fiber and the output optical fiber. The optical path between the two optical fibers remains the same when the input and output are reversed.

In another aspect of the present invention, an optical communication apparatus comprises an input optical fiber that transmits a first light beam; an output optical fiber that transmits a second light beam; a first Risley prism pair disposed in an optical path between the input optical fiber and the output optical fiber; and a second Risley prism pair disposed in the optical path between the first Risley prism pair and the output optical fiber. A first actuator for the first Risley prism pair adjusts a first deflection angle of the first Risley prism pair so that the first Risley prism pair steers the first light beam to be incident on a second outside prism face of the second Risley prism pair. A second actuator for the second Risley prism pair adjusts a second deflection angle of the second Risley prism pair so that second Risley prism pair aligns the second light beam to be incident on a first outside prism face of the first Risley prism pair, thereby forming an aligned optical path between the input optical fiber and the output optical fiber.

In still another aspect of the present invention, a 3-dimensional optical cross-connect switch comprises an input array of input optical fibers including at least one input optical fiber that transmits a first light beam; an output array of output optical fibers including at least one output optical fiber that transmits a second light beam; and a plurality of Risley prism pairs. Each input optical fiber of the input array has a distinct corresponding Risley prism pair in the plurality of Risley prism pairs, and each output optical fiber of the output array has a distinct corresponding Risley prism pair in the plurality of Risley prism pairs. A distinct first Risley prism pair of the plurality of Risley prism pairs, corresponding to the at least one input optical fiber, is disposed in an optical path between the at least one input optical fiber and the at least one output optical fiber. A distinct second Risley prism pair of the plurality of Risley prism pairs, corresponding to the at least one output optical fiber, is disposed in the optical path between the first Risley prism pair and the at least one output optical fiber. A first actuator for the first Risley prism pair adjusts a first deflection angle of the first Risley prism pair. A second actuator for the second Risley prism pair adjusts a second deflection angle of the second Risley prism pair. A controller receives first feedback signals from the first actuator, where the first actuator includes first position sensors that sense the prism angular positions of the first Risley prism pair and provides the first feedback signals to the controller. The controller provides first control signals to the first actuator that adjusts the first deflection angle so that the first Risley prism pair steers the first light beam to be incident on a second outside prism face of the second Risley prism pair. The controller receives second feedback signals from the second actuator, where the second actuator includes second position sensors that sense prism angular positions of the second Risley prism pair and provides the second feedback signals to the controller. Also, the controller provides second control signals to the second actuator that adjusts the second deflection angle so that the second Risley prism pair aligns the second light beam to be incident on a first outside prism face of the first Risley prism pair, thereby forming an aligned optical path between the input optical fiber and the output optical fiber. A signal light beam is transmitted over the aligned optical path between the at least one input optical fiber and the at least one output optical fiber.

In yet another aspect of the present invention, an optical communication system comprises a plurality of nodes with at least one of the plurality of nodes including an optical switch; and a plurality of links with each link of the plurality of links including at least one optical fiber. Each of the plurality of links optically connects two of the plurality of nodes, at least one of the plurality of links includes an input optical fiber connected to the optical switch and transmitting a first light beam, and at least one of the plurality of links includes an output optical fiber connected to the optical switch and transmitting a second light beam. The optical switch comprises a first Risley prism pair disposed in an optical path between the input optical fiber and the output optical fiber; and a second Risley prism pair disposed in the optical path between the first Risley prism pair and the output optical fiber. A first actuator for the first Risley prism pair adjusts a first deflection angle of the first Risley prism pair so that the first Risley prism pair steers the first light beam to be incident on a second outside prism face of the second Risley prism pair. A second actuator for the second Risley prism pair adjusts a second deflection angle of the second Risley prism pair so that second Risley prism pair aligns the second light beam to be incident on a first outside prism face of the first Risley prism pair, thereby forming an aligned optical path between the input optical fiber and the output optical fiber. A signal light beam is transmitted over the aligned optical path between the input optical fiber and the output optical fiber.

In even another aspect of the present invention, an optical communication system comprises a plurality of nodes and at least one link between two nodes in the plurality of nodes. A first node comprises an input optical fiber transmitting a first light beam; a first Risley prism pair disposed in an optical path between the input optical fiber and the link; and a first actuator for the first Risley prism pair, which adjusts a first deflection angle of the first Risley prism pair. A second node comprises an output optical fiber transmitting a second light beam; a second Risley prism pair disposed in the optical path between the first Risley prism pair and the output optical fiber; and a second actuator for the second Risley prism pair. The first actuator adjusts the first deflection angle so that the first Risley prism pair steers the first light beam to be incident on a second outside prism face of the second Risley prism pair. The second actuator adjusts a second deflection angle of the second Risley prism pair so that the second Risley prism pair aligns the second light beam to be incident on a first outside prism face of the first Risley prism pair, thereby forming an aligned optical path between the input optical fiber and the output optical fiber. A signal light beam is transmitted over the aligned optical path so that the first node optically communicates over the link with the second node.

In an additional aspect of the present invention, an actuator for a Risley prism pair comprises an optical path; a first drive motor; and a second drive motor. The first drive motor is connected to a first Risley prism so that a first drive motor rotation is transmitted to a first rotation of the first Risley prism about a central axis without blocking the optical path. The second drive motor is connected to a second Risley prism so that a second drive motor rotation is transmitted to a second rotation of the second Risley prism about the central axis without blocking the optical path. The second rotation and the first rotation are independent. An outside diameter of the actuator with respect to the central axis is less than 2.5 cm.

In a further aspect of the present invention, a method for optical beam alignment comprises steps of: inserting a first light beam into a first Risley prism pair; inserting a second light beam into a second Risley prism pair; adjusting the first Risley prism pair to steer the first light beam to be incident on a second outside prism face of the second Risley prism pair; and forming an aligned optical path by adjusting the second Risley prism pair to deflect the second light beam to be incident on a first outside prism face of the first Risley prism pair.

In a still further aspect of the present invention, a method for optically switching light beams in an optical switch comprises steps of: selecting an input optical fiber and an output optical fiber to be optically connected to each other; inserting a first light beam in the input optical fiber to be transmitted through a first Risley prism pair; inserting a second light beam in the output optical fiber to be transmitted through a second Risley prism pair; adjusting the first Risley prism pair to steer the first light beam to be incident on a second outside prism face of the second Risley prism pair; and adjusting the second Risley prism pair to align the second light beam to be incident on a first outside prism face of the first Risley prism pair; thereby forming an aligned optical path between the input optical fiber and the output optical fiber.

These and other features, aspects and advantages of the present invention will become better understood with reference to the following drawings, description and claims.

### BRIEF DESCRIPTION OF THE DRAWINGS

FIG. 1A is a diagram showing a hierarchy of optical communication networks in a prior art optical communication system;

FIG. 1B is a diagram for an example of a long-haul network in the hierarchy shown in FIG. 1A for prior art optical communication systems;

FIG. 1C is a diagram for an example of a metropolitan network in the hierarchy shown in FIG. 1A for prior art optical communication systems;

FIG. 1D is a diagram for an example of a building-to-building free space optical communication for prior art optical communication systems.

FIG. 2A is block diagram of a 3-dimensional optical switch, in accordance with an embodiment of the present invention;

FIG. 2B is a schematic diagram illustrating optical beam steering and alignment in a double Risley prism pair for a 3-dimensional optical switch, according to the embodiment illustrated in FIG. 2A;

FIG. 2C is a diagram of an optical path in a double Risley prism pair for a 3-dimensional optical switch, according to the embodiment illustrated in FIG. 2A, and wherein the slant faces of the prisms are oriented in a “face-to-back” fashion commonly known Risley prism pair;

FIG. 2D is a diagram of a 3-dimensional optical switch, such as the one shown in FIG. 2A, in which an optical connection cannot be made for some at least one pair of input and output optical fibers that are too far apart;

FIG. 2E is a variation of the double Risley prism pair, in which the slant faces of the prisms are oriented in a “face-to-face” fashion;

FIG. 2F is another variation of the double Risley prism pair, in which the slant faces of the prisms are oriented in a “back-to-back” fashion;

FIG. 3 is a perspective view of a prism-pair actuator for a 3-dimensional optical switch, according to an embodiment of the present invention;

FIG. 4 is a perspective view of a prism-pair actuator for a 3-dimensional optical switch, according to another embodiment of the present invention;

FIG. 5 is a cross-sectional schematic diagram view of a prism-pair actuator for a 3-dimensional optical switch, according to yet another embodiment of the present invention; and

FIG. 6 is a flow chart illustrating one example of a method for switching optical beams using a 3-dimensional optical switch, in accordance with one embodiment of the present invention.

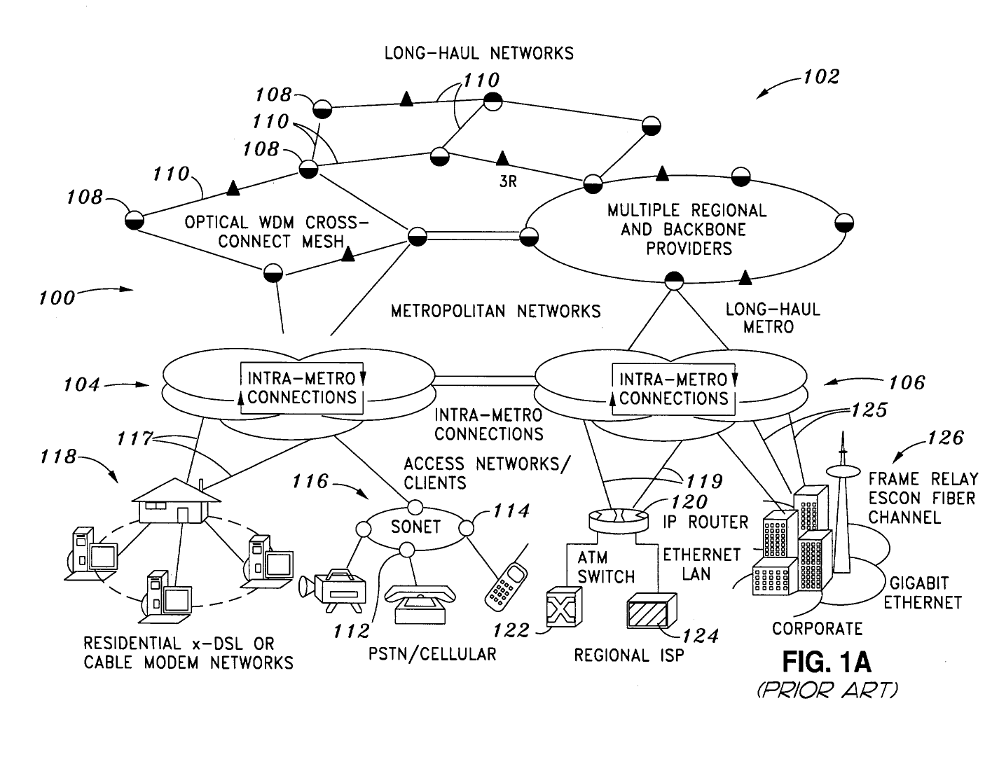

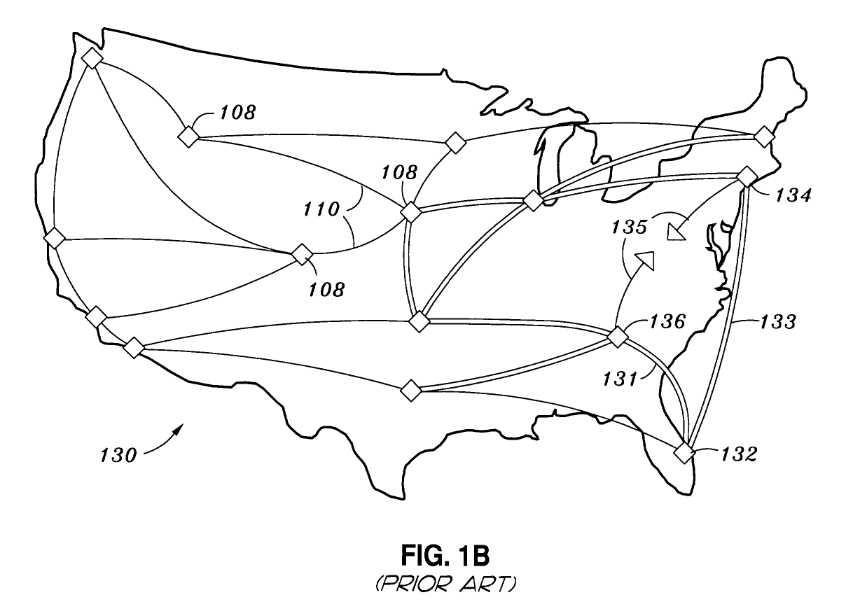

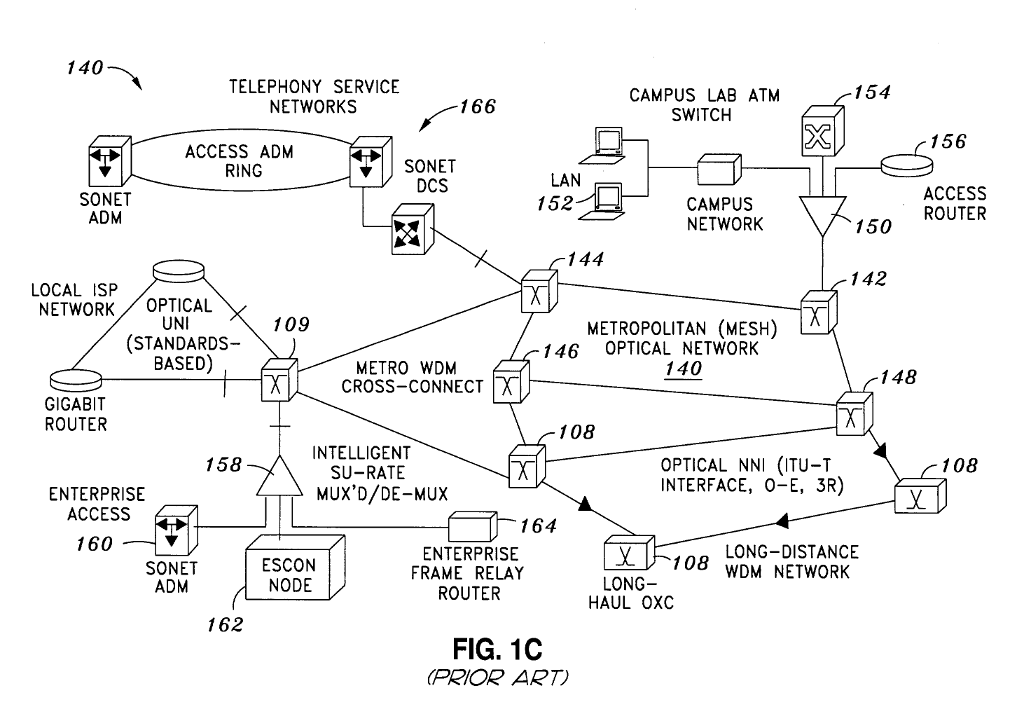

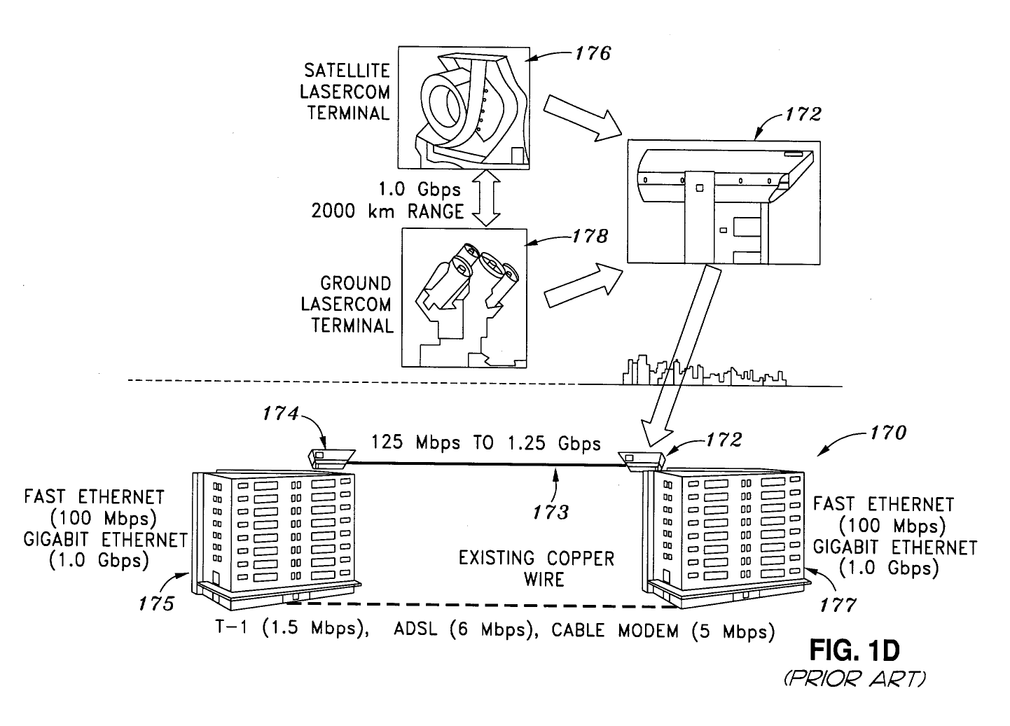

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides optical beam steering and alignment in optical communication systems—such as optical switching networks and free space optical communication systems. In one embodiment, an analog optical switch achieves accurate alignment for a practical number—such as 100 or more—of input and output optical fibers. One embodiment of the present invention may be used in the context of optical communication systems and switching networks, where optical switching may be used to provide components such as optical add/drop modules (OADM), protection switches, and non-blocking cross connect switches.

In one embodiment, the present invention uses a Risley prism pair in conjunction with each input and output optical fiber for optical beam steering and alignment so that each optical path through the switch uses two Risley prism pairs (i.e., a double Risley prism pair). A first Risley prism pair provides beam steering for the input optical fiber by directing a light beam onto the face of a second Risley prism pair. A second Risley prism pair provides beam alignment for the output optical fiber by directing a second light beam back onto the face of the first Risley prism pair. Thus, optical beam alignment for completing the optical path between a first and second optical fiber, for example, or first and second lasercom terminals, can be established without relying on a pre-existing alignment of the second optical fiber or collimating lens, as in prior art beam steering only, using one Risley prism pair. Therefore, in the present invention, an M×N multiple-channel optical switch uses M+N Risley prism pairs, while the prior art single channel optical switch uses only one Risley prism pair.

One embodiment achieves a larger Risley-prism pair optical angle, for example, as much as approximately 20 degrees of arc compared to prior art optical angles of 1.1 degrees of arc, allowing the switch of one embodiment to accommodate a practical number, such as 1,000 or more, of input and output optical fibers while maintaining beam steering accuracy and improving beam alignment.

Another embodiment may be used in the context of free space optics, where optical communication is between two locations, such as buildings, with line of sight currently being accomplished by laser beam steering using tilting mirrors or mechanical gimbals mechanisms. The present invention of double Risley prism pairs can be employed for the same beam steering function achieved by past tilting mirrors. For this application, the double Risley prism pairs provide an improvement over the tilting mirror or gimbals mechanism approach because the optical alignment is less sensitive to mechanical angle variations of the Risley prisms than the tilting mirrors.

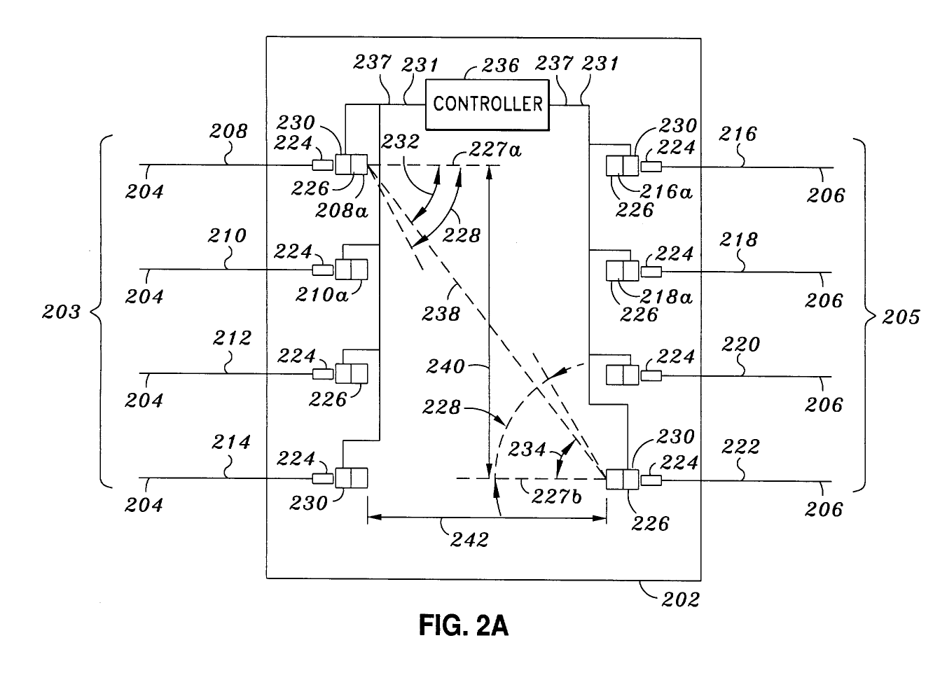

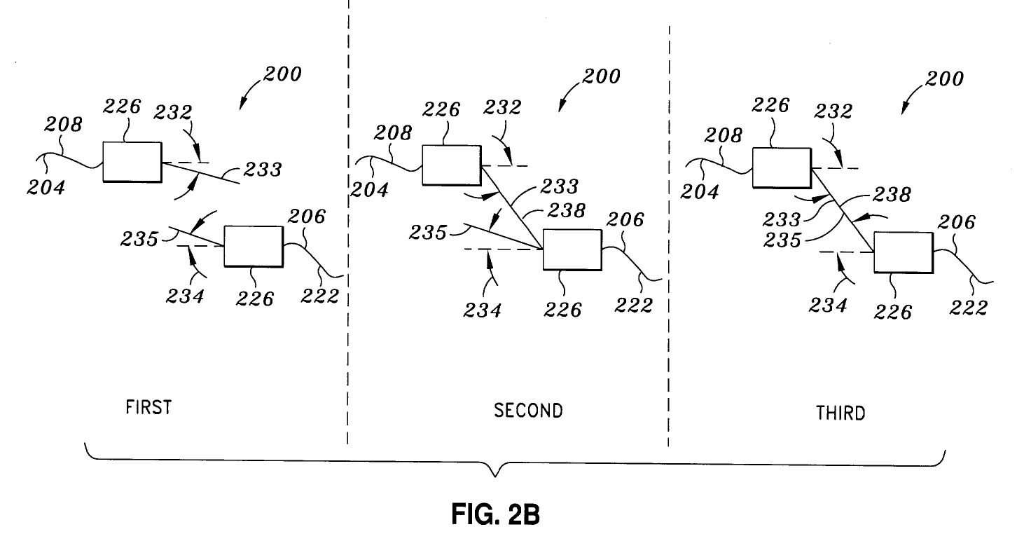

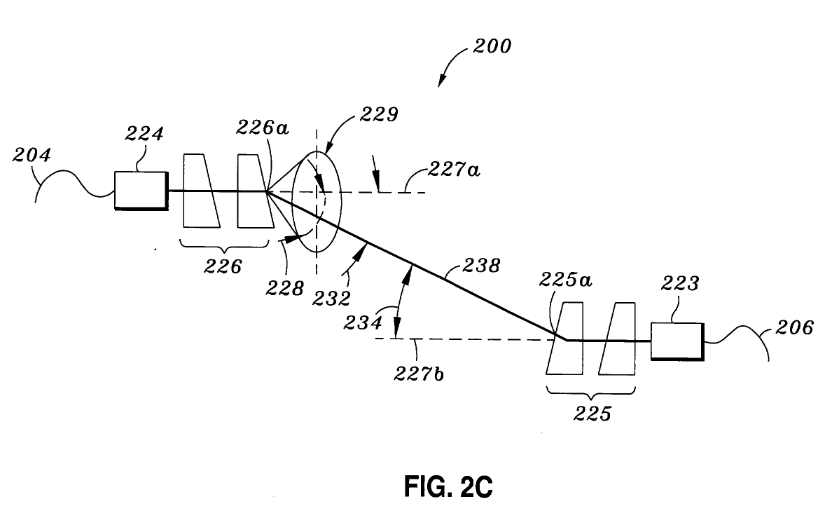

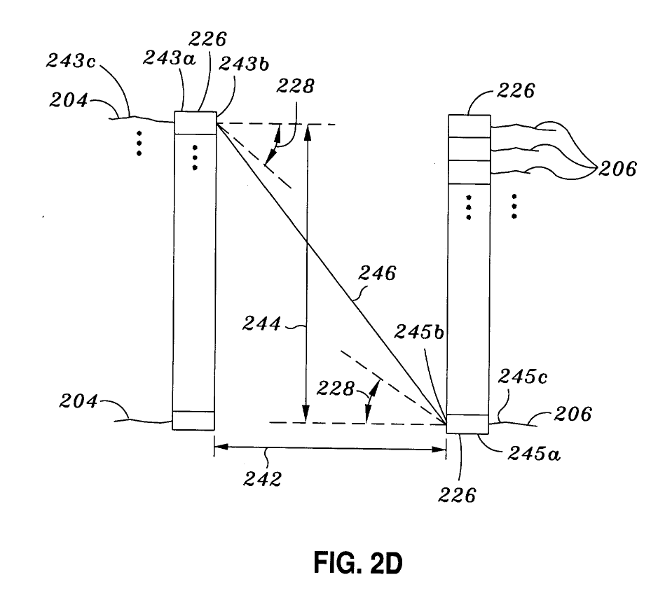

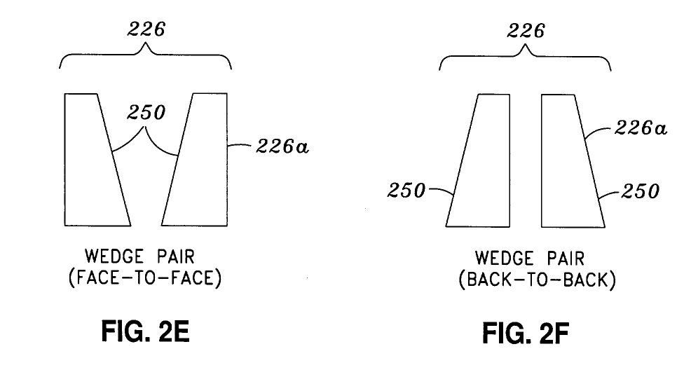

Referring now to FIG. 2A, double Risley prism pair (DRPP) optical switch 202, which may be a 3-dimensional all-optical (OOO) fiber optical switch employing Risley prism pairs, according to one embodiment is illustrated. DRPP optical switch 202 may include an input array 203 of input optical fibers for transmitting light signals and an output array 205 of output optical fibers for transmitting light signals. Because light can propagate in either direction along an optical fiber, the terms “input” and “output” are used for convenience and do not necessarily limit the direction of signal propagation. Input array 203 may include a plurality of input optical fibers such as 208, 210, 212, and 214. Output array 205 may include a plurality of output optical fibers such as 216, 218, 220, and 222. Although exemplary DRPP optical switch 202 is illustrated with an equal number of input and output optical fibers, it is generally the case that the number of input optical fibers need not equal the number of output optical fibers.

Each of input optical fibers 208, 210, 212, and 214 of input array 203 and each of output optical fibers 216, 218, 220, and 222 of output array 205 may include a collimator 224. Collimator 224 may include a glass capillary, as known in the art, surrounding the end of the optical fiber and surrounding a collimating lens, which may be a graded index, or grin, lens, with the glass capillary holding the end of the optical fiber in proximity to the collimating lens. Each collimator 224 is disposed to direct light from the optical fiber into a corresponding Risley prism pair 226. As known in the art, each Risley prism pair may comprise a pair of optical glass prisms rotatable about a common axis 227a, and capable of deflecting a beam of light entering the prism pair parallel to the axis 227a within a cone 229, illustrated in FIG. 2C, whose axis of symmetry coincides with the common axis 227a of rotation of the Risley prism pair 226. The apex angle of the cone 229, i.e., the maximum angle of deflection of the beam of light, may be referred to as the optical angle of the Risley prism pair, for example, optical angle 228 shown in FIGS. 2A, 2C, and 2D.

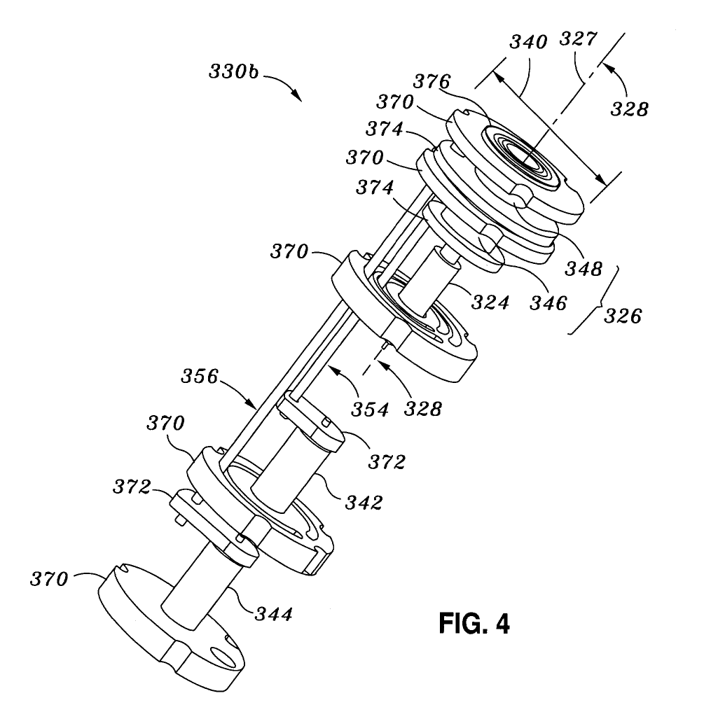

Each Risley prism pair 226 may be connected to an actuator 230, exemplary embodiments of which are illustrated in FIGS. 4, 5, and 6. The exemplary embodiments illustrated in FIGS. 4, 5, and 6 and more fully described below, in contrast to prior art actuators, have minimized outside diameter 340 in order to maximize the number of input and output optical fibers that may be handled by a single switch, such as switch 202. Each actuator 230 may be capable of independently rotating each Risley prism of each Risley prism pair, as more clearly seen with reference to FIGS. 4, 5, and 6, for deflecting each light beam to a selected angle of deflection, such as deflection angle 232 and deflection angle 234, seen in FIG. 2B.

Each actuator 230 may be connected, as shown in FIG. 2A, to a controller 236. Controller 236 may be implemented, for example, using one or more microprocessors. Controller 236 may be configured to provide control signals 237 to each actuator 230 and to receive feedback signals 231 from each actuator 230 for controlling deflection angle 232, for example, to provide optical beam steering, as illustrated in FIG. 2B by the transition from the “First” part of FIG. 2B to the “Second” and for controlling deflection angle 234, for example, to provide optical beam alignment, as illustrated in FIG. 2B by the transition from the “Second” part of FIG. 2B to the “Third”, for forming a complete optical path 238, for example, from optical fiber 208 to optical fiber 222.

The transition from the “First” part of FIG. 2B to the “Second” part of FIG. 2B, for example, illustrates an adjustment to deflection angle 232 so that light beam 233, shown in the “First” part of FIG. 2B as not lying on any optical path between Risley prism pairs 226, is directed to lie on optical path 238 between Risley prism pairs 226 as shown in the “Second” part of FIG. 2B. Similarly, the transition from the “Second” part of FIG. 2B to the “Third” part of FIG. 2B, for example, illustrates an adjustment to deflection angle 234 so that light beam 235, shown in the “Second” part of FIG. 2B as not lying on any optical path between Risley prism pairs 226, is directed to lie on optical path 238 between Risley prism pairs 226 as shown in the “Third” part of FIG. 2B. After the adjustment to the second deflection angle—in this example, deflection angle 234—a complete optical path 238, as described above, from optical fiber 208 to optical fiber 222 may be aligned and established for optical communications.

The controller 236 is a functional element of the system, and it should not be considered as a physical unit since there are numerous controller hardware structures and software architectures in the prior art that can realize the disclosed function of beam steering, aligning, and switching.

Because each optical fiber connected to DRPP optical switch 202, such as input optical fibers 208, 210, 212, 214 and output optical fibers 216, 218, 220, and 222, has a corresponding Risley prism pair—such as input Risley prism pair 208a, shown FIG. 2A, corresponding to input optical fiber 208 and output Risley prism pair 218a corresponding to output optical fiber 218, any input-output fiber pair comprising an input optical fiber and an output optical fiber may be optically connected. For example, pair 208 and 222 may be connected as illustrated by light path 238. Thus, DRPP optical switch 202 may optically connect any one of input optical fibers—such as 208, 210, 212, and 214 of input array 203—with any one of output optical fibers—such as 216, 218, 220, and 222 of output array 205.

In the example shown in FIG. 2A, with four input optical fibers and four output optical fibers there are 4×4=16 distinct pairs which may be optically connected to function simultaneously. Thus, DRPP optical switch 202 may provide connection for any permutation of input optical fibers—such as 208, 210, 212, and 214—to output optical fibers—such as 216, 218, 220, and 222. With input array 203 used as working, i.e., signal transmitting, inputs and output array 205 used as working outputs, DRPP optical switch 202 may be connected for use as a 4×4 non-blocking cross-connect switch in a switch network, such as metro telecommunications switching network 104 in optical communication system hierarchy 100, for example, where “non-blocking”, as understood in the art, means that any one of working inputs of input array 203 may be connected to any one of working outputs of output array 205 without blocking the possibility of any other working input from input array 203 from being connected to an unused working output of output array 205. Thus, as an example, if input optical fiber 208 is connected to output optical fiber 216, any one of input optical fibers 210, 212, and 214 of input array 203 may still be simultaneously connected with any one of output optical fibers 218, 220, and 222 of output array 205.

Because DRPP optical switch 202 has four each of working inputs and outputs for illustration, DRPP optical switch 202 is designated as a 4×4 switch. It is contemplated, however, that any same or different number of inputs and outputs could be provided so that, for example, a 1000×2000 switch could be provided and used as a non-blocking cross-connect switch in a similar manner.

In another aspect of the present invention, some input optical fibers of input array 203 can be used as working inputs and some as protection inputs, and some output optical fibers of output array 205 can be used as working outputs and some as protection outputs, where “protection” is used in the sense of providing redundant, or backup, signal paths, as understood in the art. Thereby, DRPP optical switch 202 may be connected for use as a protection switch, as understood in the art. In another aspect of the present invention, some input optical fibers of input array 203 can be used as working inputs and some as add inputs, as known in the art, and some output optical fibers of output array 205 can be used as working outputs and some as drop outputs, as known in the art. Thus, DRPP optical switch 202 may be connected for use as an optical add/drop module, or OADM, as understood in the art.

Referring now to FIGS. 2B and 2C, a double Risley prism pair 200 for forming optical path 238, for example, in a fiber optical switch—such as DRPP optical switch 202—or, for example, in a free space optical communication system—such as free space optical communication system 170—according to one embodiment is illustrated. Optical path 238 from input optical fiber 204 (including collimator 224) to output optical fiber 206 (including collimator 223) may be formed by placing a first Risley prism pair 226 into optical path 238 between input optical fiber 204 and output optical fiber 206, and also by placing a second Risley prism pair 225 into optical path 238 between first Risley prism pair 226 and output optical fiber 206. The prisms of first Risley prism pair 226 may be rotated about axis 227a to adjust deflection angle 232 to steer a first light beam 233, seen in FIG. 2B, along optical path 238 to be incident on an outside prism face 225a of second Risley prism pair 225. Similarly, the prisms of second Risley prism pair 225 may be rotated about axis 227b to adjust deflection angle 234 to align a second light beam 235, seen in FIG. 2B, along optical path 238 to be incident on an outside prism face 226a of first Risley prism pair 226 and to coincide with the first light beam 233. By adjusting deflection angle 234, as seen in the transition from the “Second” part to the “Third” part of FIG. 2B, until the second light beam 235 coincides with the first light beam 233 along optical path 238, alignment of optical path 238 may be effected.

Thus, by way of contrast to the prior art, there is no need for precise alignment of axis 227a relative to axis 227b, nor for any precise alignment of collimators 223 or 224 relative to each other, in the present invention. So long as the placement and alignment of axes 227a and 227b relative to each other allows formation of optical path 238 within the Risley prism pair optical angle 228 (as shown in FIGS. 2A and 2C) precise alignment of axis 227a relative to axis 227b and precise alignment of optical fibers 204 and 206 (or collimators 223, 224) relative to each other is not required because the angular adjustment of the deflection angles 232, 234 of the two Risley prism pairs 225, 226 (within the optical angle 228 of the Risley prism pairs) compensates for any misalignment between the optical fibers.

More specifically, in the present invention, because the light paths are reversible (i.e., light propagating in the reverse direction along the same path follows that same path), an optical beam alignment for completing the optical path between the input optical fiber and the output optical fiber (i.e., “first light” as known in the art), can be established so long as the optical path from the second light beam (from the output optical fiber) is sufficiently close to the optical path of the first light beam to pass in the reverse direction through the first Risley prism pair and enter the input optical fiber. For example, if the second light beam overlaps the first light beam between the two Risley prism pairs, the two light beams will have a reversible light path in common so that a first light for optical beam alignment can be established.

The drawings (FIGS. 2B and 2C) and the above description refer only to one angle, i.e., the “deflection angle”. However, it should be understood that actually there are two angles adjusted simultaneously by the rotational angles of the two prisms in one Risley prism pair, as known in the art, and disclosed in U.S. patent application Publication No. US20010046345 A1, published Nov. 29, 2001, and incorporated herein by reference. In particular, paragraph [0022] describes the “net deflection” of the Risley prism pair (referred to as “deflection” in the present description) in terms of the “deflection for each prism”.

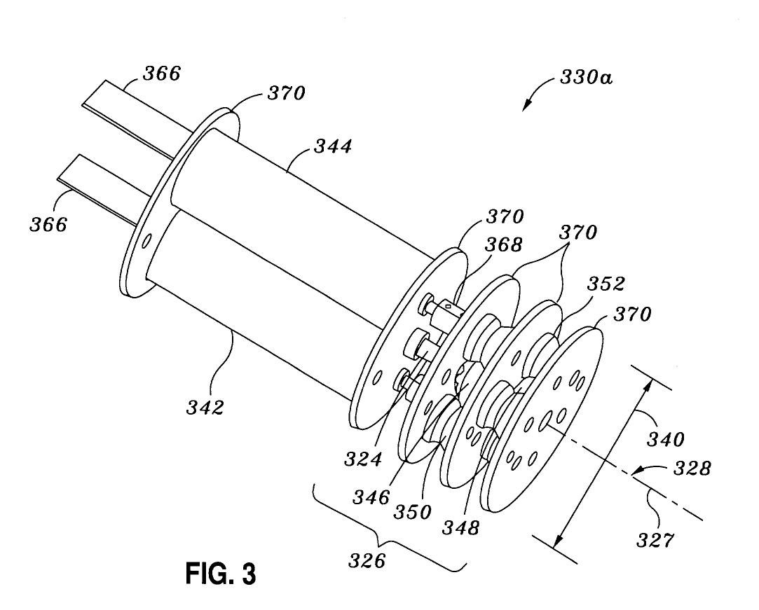

As seen in the example shown in FIG. 2A, where the Risley prism pair axes 227a and 227b are parallel to each other, the perpendicular distance 240 between the Risley prism pair axes 227a and 227b of the most widely separated optical fibers, such as optical fibers 208 and 222, should fit within the optical angle 228 (i.e., perpendicular distance 240 should be less than the product of the separation distance 242 between input and output Risley prism pairs and the tangent of the optical angle 228) in order for any input optical fiber, such as optical fiber 208, to be optically connected to any output fiber, such as optical fibers 216, 218, 220, and 222. Thus, for a given separation distance 242, the optical angle 228 limits the perpendicular distance 240 between the most widely separated optical fibers, such as 208 and 222, between which an optical path 238 can be formed. Therefore, the maximum number of optically connectable input and output optical fibers is limited by the number of Risley prism pairs that can be disposed within the perpendicular distance 240. Because each optical fiber is surrounded by its associated actuator 230, if an outside diameter 340 (shown in FIGS. 3, 4, and 5) with respect to central axis 327 of each Risley prism pair and its associated actuator 230 can be made smaller, more optical fibers can be fitted within the perpendicular distance 240 in such a way as to allow switching between any pair of input and output optical fibers, such as 208 and 222. Although other geometrical arrangements for each Risley prism pair's optical axis orientation and the three-dimensional position may be contemplated and optimized for maximal channel density, it is understood that the maximum number of optical fibers would be limited by the optical angle 228 and outside diameter 340 of the Risley prism pairs and their associated actuators, i.e., the smaller the optical angle 228, the smaller the maximum number of optical fibers and the larger the outside diameter 340, the smaller the maximum number of optical fibers.

In other words, as shown in FIG. 2D, if the number of Risley prism pairs 226 placed side-to-side causes perpendicular distance 244 between a pair of optical fibers, or between the associated Risley prism pairs, such as 143a and 145a, to be too great relative to separation distance 242, then line 246 connecting face 243b of Risley prism pair 243a and face 245b of Risley prism pair 245a will lie outside optical angle 228 so that no optical path can be formed between Risley prism pair 243a and Risley prism pair 245a. In other words, switching between all pairs of input and output optical fibers is no longer achieved because optical fiber 243c cannot be switched to optical fiber 245c. Therefore, in order to maximize the number of input and output optical fibers in DRPP optical switch 202 in such a way that an optical path can be formed for every pair of input and output optical fibers within the optical angle of the Risley prism pairs, it is desirable to provide Risley prism pairs with associated actuators having the smallest possible outside diameter 340 (as more clearly shown in FIGS. 3, 4, and 5) with respect to central axis 327.

FIG. 2E illustrates an alternative implementation to the double Risley prism pair shown in FIG. 2C, in which the slant faces 250 of the prisms are oriented in a “face-to-face” fashion so that the outside prism face 226a is not a slant face 250. Similarly, FIG. 2F illustrates an alternative implementation to the double Risley prism pair shown in FIG. 2C, in which the slant faces 250 of the prisms are oriented in a “back-to-back” fashion so that the outside prism face 226a is a slant face 250. One advantage of these two alternative implementations is that the prism's reachable optical range, as it is projected on a plane, is a closed contour without a hole in it, while the conventional Risley prism pair generates a donut like shape, where a hole in the contour cannot be optically reached.

FIG. 3 shows a perspective view of prism-pair actuator 330a for a 3-dimensional analog optical switch, according to an embodiment of the present invention. Actuator 330a may include drive motors 342, 344 each connected to a prism 346, 348 of a Risley prism pair 326. Drive motors 342, 344 may be electrical stepper or DC motors, for example, as known in the art. Drive motors 342, 344 may be connected to prisms 346, 348 through reduction drives 350, 352. Reduction drives 350, 352 may use traction (friction) or gear contact to independently transmit actuator rotation of drive motors 342, 344 to rotation of prisms 346, 348 about central axis 327 without blocking optical path 328 through collimator 324. Thus, drive motor 342 may be independently controlled to provide rotation of prism 346 independent of rotation of prism 348, and drive motor 344 may be independently controlled to provide rotation of prism 348 independent of rotation of prism 346. Reduction drives 350, 352 may be used to provide a reduction or amplification ratio between rotation of drive motors 342, 344 and driven prisms 346, 348, depending on the tradeoff between response speed and motor torque. For the situation where fast response speed is required, the reduction gear may not be needed and a direct coupling, for example, between the motor shaft and the prism drive may be used.

FIG. 3 also shows a wiring harness 366 for each of drive motors 342, 344. Each wiring harness 366 may include wires, for example, for supplying drive motors 342, 344 with power, providing control signals—such as control signals 237—to drive motors 342, 344, and providing feedback signals—such as feedback signals 231—from, for example, position sensors, also referred to as “resolvers”, which may be incorporated within drive motors 342, 344 for position sensing. Resolvers may provide a feedback signal 231 containing information about the angle of rotation of each of prisms 346, 348 to a controller, such as controller 236, shown in FIG. 2A. Resolvers may be substituted by, for example, potentiometers, encoders, or other position sensing devices. Alternatively, position-sensing feedback may not be needed, and so not be used, when the mechanical system, for example, stepper motor and harmonic drive, provides sufficient mechanical precision. FIG. 3 also shows couplings 368, which may be used for coupling drive motors 342, 344 to reduction drives 350, 352, and mounting plates 370, which may provide a mechanically stable attachment, for example, to a case (not shown). In one embodiment, actuator outside diameter 340 with respect to central axis 327 may be reduced to less than 2.5 centimeter (cm), and it is contemplated that diameter 340 may be reduced to less than 1.0 cm.

FIG. 4 shows a perspective view of prism-pair actuator 330b for a 3-dimensional optical switch, according to another embodiment of the present invention. Actuator 330b may include drive motors 342, 344 each connected to a prism 346, 348 of a Risley prism pair 326. Drive motors 342, 344 may be electrical stepper or DC servo motors, or piezoelectric rotary motors, for example, as known in the art. Drive motors 342, 344 may be connected to prisms 346, 348 through cranks 372 and connecting rods 354, 356. Cranks 372 may transfer torque or rotational motion from drive motors 342, 344 to connecting rods 354, 356. Connecting rods 354, 356 may independently transmit rotation of actuator drive motors 342, 344 to rotation of prisms 346, 348 about central axis 327 without blocking optical path 328 through collimator 324. Thus, drive motor 342 may be independently controlled to provide rotation of prism 346 independent of rotation of prism 348, and drive motor 344 may be independently controlled to provide rotation of prism 348 independent of rotation of prism 346.

Drive motors 342, 344 may be arranged in line with central axis 327, as shown, to reduce the actuator module cross sectional area by reducing diameter 340. FIG. 4 also shows prism holders 374, which may secure prisms 346, 348 and transfer rotation from connecting rods 354, 356 to prisms 346, 348. FIG. 4 also shows bearing 376, which may provide rotational support for prisms 346, 348. In one embodiment, actuator outside diameter 340 with respect to central axis 327 may be reduced to less than 2.5 cm, and it is contemplated that diameter 340 may be reduced to less than 1.0 cm.

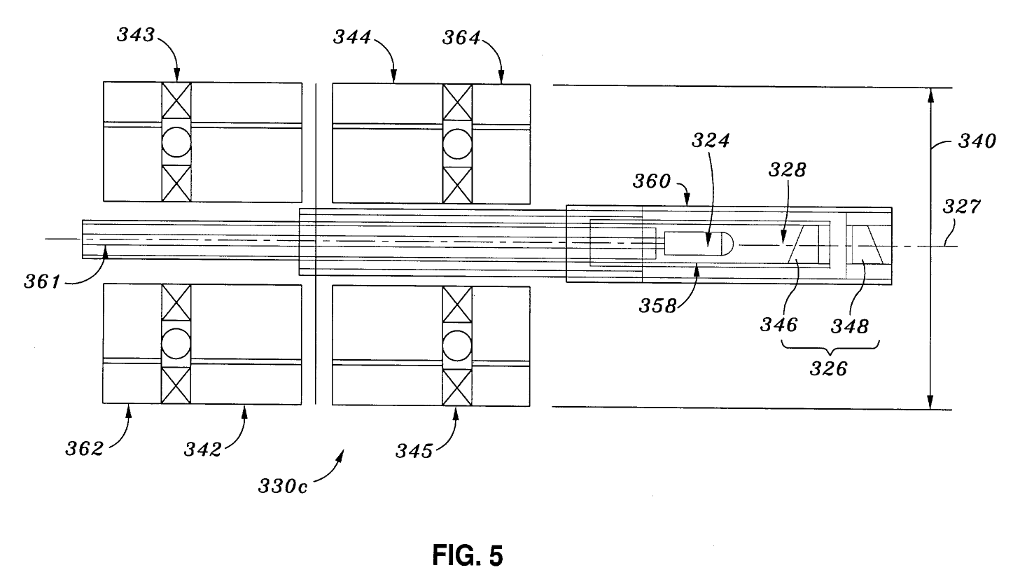

FIG. 5 shows a cross-sectional schematic diagram view of yet another prism-pair actuator 330c for a 3-dimensional optical switch, according to another embodiment of the present invention. Actuator 330c may include drive motors 342, 344 each connected to a prism 346, 348 of a Risley prism pair 326. Drive motors 342, 344 may be hollow-shaft, frameless, electrical stepper, DC servo or piezoelectric motors rotating on bearings 343, 345, for example, as known in the art. Drive motors 342, 344 may be connected to prisms 346, 348 through hollow shafts 358, 360. Hollow shafts 358, 360 may surround optical path 328 and independently transmit actuator rotation of drive motors 342, 344 to rotation of prisms 346, 348 about central axis 327 without blocking optical path 328 through collimator 324, which may be supported on a third shaft 361. For example, hollow shafts 358, 360 may be constructed from stainless steel micro tubing. Hollow shaft 358 may have an inside diameter of 2.0 millimeters (mm) and an outside diameter of 2.5 mm. Hollow shaft 360 may have an inside diameter of 3.0 mm and an outside diameter of 3.5 mm.

Thus, drive motor 342 may be independently controlled to provide rotation of prism 346 independent of rotation of prism 348, and drive motor 344 may be independently controlled to provide rotation of prism 348 independent of rotation of prism 346. Actuator 330c may also include position sensors 362, 364 for position sensing and providing feedback signals containing information about the angle of rotation of each of prisms 346, 348 to a controller, such as controller 236, shown in FIG. 2A. Position sensors 362, 364 may be substituted by, for example, potentiometers, encoders, or other position sensing devices. Alternatively, position-sensing feedback may not be needed, and so not be used, when the motor, for example, stepper motor can provide sufficient mechanical precision without closed loop control. Drive motors 342, 344 may be arranged in line with central axis 327, as shown, to reduce the actuator module cross sectional area by reducing diameter 340. In one embodiment, actuator outside diameter 340 with respect to central axis 327 may be reduced to less than 2.5 cm, and it is contemplated that diameter 340 may be reduced to less than 1.0 cm.

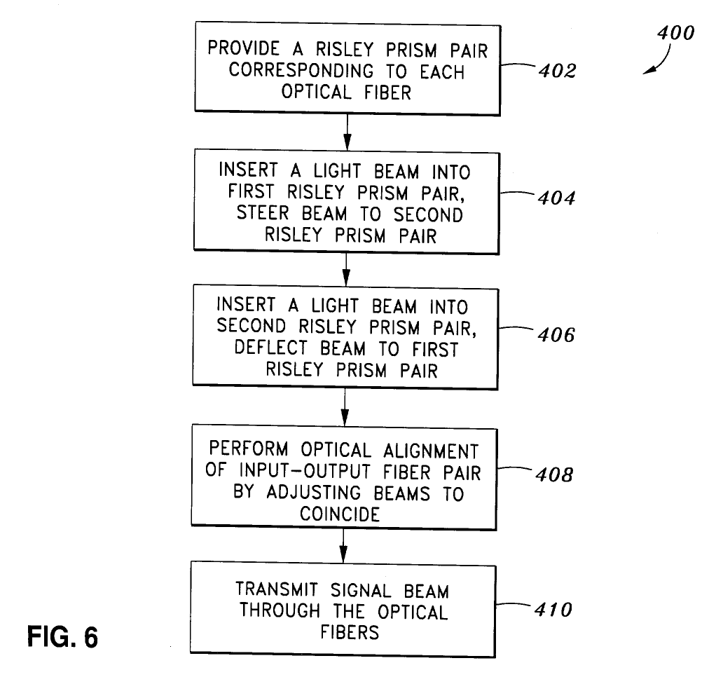

Referring now to FIG. 6, a method of optical beam steering and alignment for optically switching light beams is illustrated depicting exemplary method 400 in accordance with one embodiment. Method 400 may include a step 402 in which a Risley prism pair 226 may be provided for a first optical fiber and a Risley prism pair 225 may be provided for a second optical fiber. More generally, a first plurality of Risley prism pairs 226 may be provided in such a way that an input Risley prism pair 226 is provided corresponding to each optical fiber of an input array 203 of input optical fibers 204. For example, input Risley prism pair 208a may be provided corresponding to input optical fiber 208 and input Risley prism pair 210a may be provided corresponding to input optical fiber 210, as shown in FIG. 2A. Step 402 may further include providing a second plurality of Risley prism pairs 226 in such a way that an output Risley prism pair 226 is provided corresponding to each optical fiber of an output array 205 of output optical fibers 206. For example, output Risley prism pair 216a may be provided corresponding to output optical fiber 216 and output Risley prism pair 218a may be provided corresponding to output optical fiber 218, as shown in FIG. 2A. Risley prism pairs 226 may be disposed, as described above, so that it is not required for any deflection angle, such as deflection angle 232 or 234, for example, to exceed the Risley prism pair optical angle 228 in order to form an optical path between any input-output fiber pair comprising an input optical fiber of input array 203 and an output optical fiber of output array 205.

Method 400 may include a step 404 in which a light beam is inserted into a first Risley prism pair corresponding to an input optical fiber of input array 203, for example, Risley prism pair 226 and the light beam is steered to be incident on a second Risley prism pair corresponding to an output optical fiber of output array 205, for example, Risley prism pair 225 by adjusting the first Risley prism pair.

Method 400 may include a step 406 in which a light beam is inserted into the second Risley prism pair, for example, Risley prism pair 225 and the light beam is aligned to be incident on the first Risley prism pair, for example, Risley prism pair 226 by adjusting the second Risley prism pair 225.

Method 400 may include a step 408 in which optical alignment of the input optical fiber of input array 203 corresponding to the first Risley prism pair with the output optical fiber of output array 205 corresponding to the second Risley prism pair is performed by adjusting the second Risley prism pair, for example, by rotating the prisms of second Risley prism pair 225 as known in the art, to align the second light beam to coincide with the first light beam to form an optical path, for example, optical path 238.

Method 400 may include a step 410 in which optical switching is performed by transmitting a signal over the optical path, for example, optical path 238 between the input optical fiber of input array 203 corresponding to the first Risley prism pair and the output optical fiber of output array 205 corresponding to the second Risley prism pair.

It should be understood, of course, that the foregoing relates to preferred embodiments of the invention and that modifications may be made without departing from the spirit and scope of the invention as set forth in the following claims.

We claim:

1. An optical communication apparatus comprising:
an input optical fiber transmitting a first light beam;
an output optical fiber transmitting a second light beam;
a first Risley prism pair disposed in an optical path between said input optical fiber and said output optical fiber; and
a second Risley prism pair disposed in said optical path between said first Risley prism pair and said output optical fiber, wherein:
said first Risley prism pair steers said first light beam to be incident on said second Risley prism pair, and
said second Risley prism pair aligns said second light beam to be incident on said first Risley prism pair, thereby forming an aligned optical path between said input optical fiber and said output optical fiber.

2. The optical communication apparatus of claim 1, further comprising:
an input array of input optical fibers;
an output array of output optical fibers; and
a plurality of Risley prism pairs wherein:
each of said input optical fibers has a corresponding input Risley prism pair in said plurality of Risley prism pairs, and
each of said output optical fibers has a corresponding output Risley prism pair in said plurality of Risley prism pairs.

3. The optical communication apparatus of claim 1, further comprising an actuator for said first Risley prism pair, wherein said actuator adjusts a deflection angle of said first Risley prism pair.

4. The optical communication apparatus of claim 3, further comprising a controller that receives feedback signals from said actuator and provides control signals to said actuator.

5. The optical communication apparatus of claim 4 wherein said actuator includes a position sensor that senses a position of a prism of said first Risley prism pair and provides a feedback signal to said controller.

6. The optical communication apparatus of claim 1 wherein a signal light beam is transmitted over said aligned optical path.

7. The optical communication apparatus of claim 1 wherein an optical angle of said first Risley prism pair is at least 1.1 degrees.

8. The optical communication apparatus of claim 2 wherein said input array and said output array are connected for use as a non-blocking cross-connect switch in a switching network.

9. The optical communication apparatus of claim 2 wherein said input array and said output array are connected for use as a protection switch in a switching network.

10. The optical communication apparatus of claim 2 wherein said input array and said output array are connected for use as an optical add/drop module in a switching network.

11. An optical communication apparatus comprising:
an input optical fiber that transmits a first light beam;
an output optical fiber that transmits a second light beam;
a first Risley prism pair disposed in an optical path between said input optical fiber and said output optical fiber; and
a second Risley prism pair disposed in said optical path between said first Risley prism pair and said output optical fiber;
a first actuator for said first Risley prism pair, wherein said first actuator adjusts a first deflection angle of said first Risley prism pair so that said first Risley prism pair steers said first light beam to be incident on a second outside prism face of said second Risley prism pair;
a second actuator for said second Risley prism pair, wherein said second actuator adjusts a second deflection angle of said second Risley prism pair so that second Risley prism pair aligns said second light beam to be incident on a first outside prism face of said first Risley prism pair, thereby forming an aligned optical path between said input optical fiber and said output optical fiber.

12. The optical communication apparatus of claim 11 wherein a signal light beam is transmitted in free space over said aligned optical path between said input optical fiber and said output optical fiber.

13. The optical communication apparatus of claim 11, further comprising:
an input array of input optical fibers;
an output array of output optical fibers; and
a plurality of Risley prism pairs wherein:
each of said input optical fibers has a corresponding input Risley prism pair in said plurality of Risley prism pairs, and
each of said output optical fibers has a corresponding output Risley prism pair in said plurality of Risley prism pairs.

14. The optical communication apparatus of claim 13 wherein:
said input array comprises working optical fibers and protection optical fibers;
said output array comprises working optical fibers and protection optical fibers; and
said optical communication apparatus is connected for use as a protection switch.

15. The optical communication apparatus of claim 13 wherein:
said input array comprises working optical fibers and add optical fibers;
said output array comprises working optical fibers and drop optical fibers; and
said optical communication apparatus is connected for use as an add/drop module.

16. The optical communication apparatus of claim 13 wherein:
said input array comprises working optical fibers;
said output array comprises working optical fibers; and
said optical communication apparatus is connected for use as a non-blocking cross-connect switch.

17. The optical communication apparatus of claim 11 wherein said first actuator has an outside diameter with respect to a central axis that is less than 2.5 cm.

18. The optical communication apparatus of claim 11 wherein an optical angle of said first Risley prism pair is at least 1.1 degrees.

19. The optical communication apparatus of claim 11 wherein said first actuator comprises an electrical motor that rotates a prism of said first Risley prism pair about a central axis.

20. The optical communication apparatus of claim 19 wherein said electrical motor is positioned in line with said central axis and is connected to said prism by a connecting rod.

21. The optical communication apparatus of claim 19 wherein said electrical motor is coupled to said prism by a friction reduction drive.

22. The optical communication apparatus of claim 19 wherein said electrical motor is a hollow-shaft motor wherein a hollow shaft surrounds said optical path.

23. The optical communication apparatus of claim 11, further comprising a controller that:
receives a first feedback signal from said first actuator wherein said first actuator includes a position sensor that senses a position of a prism of said first Risley prism pair and provides said first feedback signal to said controller; and
provides a first control signal to said first actuator.

24. A 3-dimensional optical cross-connect switch comprising:
an input array of input optical fibers comprising at least one input optical fiber that transmits a first light beam;
an output array of output optical fibers comprising at least one output optical fiber that transmits a second light beam;
a plurality of Risley prism pairs wherein:
each of said input optical fibers has a corresponding input Risley prism pair in said plurality of Risley prism pairs, and
each of said output optical fibers has a corresponding output Risley prism pair in said plurality of Risley prism pairs;
a first Risley prism pair of said plurality of Risley prism pairs, corresponding to said at least one input optical fiber, and disposed in an optical path between said at least one input optical fiber and said at least one output optical fiber; and
a second Risley prism pair of said plurality of Risley prism pairs, corresponding to said at least one output optical fiber, disposed in said optical path between said first Risley prism pair and said at least one output optical fiber;
a first actuator for said first Risley prism pair, wherein said first actuator adjusts a first deflection angle of said first Risley prism pair;
a second actuator for said second Risley prism pair, wherein said second actuator adjusts a second deflection angle of said second Risley prism pair
a controller that:
receives a first feedback signal from said first actuator wherein said first actuator includes a first position sensor that senses a first prism position of said first Risley prism pair and provides said first feedback signal to said controller;
provides a first control signal to said first actuator that adjusts said first deflection angle so that said first Risley prism pair steers said first light beam to be incident on a second outside prism face of said second Risley prism pair;
receives a second feedback signal from said second actuator wherein said second actuator includes a second position sensor that senses a second prism position of said second Risley prism pair and provides said second feedback signal to said controller;
provides a second control signal to said second actuator that adjusts said second deflection angle so that said second Risley prism pair aligns said second light beam to be incident on a first outside prism face of said first Risley prism pair, thereby forming an aligned optical path between said input optical fiber and said output optical fiber wherein a signal light beam is transmitted over said aligned optical path between said at least one input optical fiber and said at least one output optical fiber.

25. The 3-dimensional optical cross-connect switch of claim 24 further comprising:
a second input optical fiber;
a second output optical fiber wherein:
said at least one input optical fiber is connected as a working fiber;
said second input optical fiber is connected as a protection fiber;
said at least one output optical fiber is connected as a working fiber;
said second output optical fiber is connected as a protection fiber; and
said 3-dimensional optical cross-connect switch is connected for use as a protection switch.

26. The 3-dimensional optical cross-connect switch of claim 24 further comprising:
a second input optical fiber;
a second output optical fiber wherein:
said at least one input optical fiber is connected as a working fiber;
said second input optical fiber is connected as an add fiber;
said at least one output optical fiber is connected as a working fiber;
said second output optical fiber is connected as a drop fiber; and
said 3-dimensional optical cross-connect switch is connected for use as an add/drop module.

27. The 3-dimensional optical cross-connect switch of claim 24 wherein:
said at least one input optical fiber is connected as a working fiber;
said at least one output optical fiber is connected as a working fiber; and
said 3-dimensional optical cross-connect switch is connected for use as a non-blocking cross-connect switch.

28. The 3-dimensional optical cross-connect switch of claim 24 wherein said first actuator has an outside diameter with respect to a central axis that is between 2.5 cm and 1.0 cm.

29. The 3-dimensional optical cross-connect switch of claim 24 wherein said first actuator has an outside diameter with respect to a central axis that is between 0.5 cm and 1.0 cm.

30. The 3-dimensional optical cross-connect switch of claim 24 wherein a optical angle of said first Risley prism pair is between 1.1 degrees and 10 degrees.

31. An optical communication system comprising:
a plurality of nodes wherein at least one node of said plurality of nodes comprises an optical switch;
a plurality of links wherein:
each link of said plurality of links comprises at least one optical fiber,
each link of said plurality of links optically connects two nodes of said plurality of nodes,
at least one link of said plurality of links includes an input optical fiber connected to said optical switch and transmitting a first light beam, and
at least one link of said plurality of links includes an output optical fiber connected to said optical switch and transmitting a second light beam;
wherein said optical switch comprises:
a first Risley prism pair disposed in an optical path between said input optical fiber and said output optical fiber; and
a second Risley prism pair disposed in said optical path between said first Risley prism pair and said output optical fiber;
a first actuator for said first Risley prism pair, wherein said first actuator adjusts a first deflection angle of said first Risley prism pair so that said first Risley prism pair steers said first light beam to be incident on a second outside prism face of said second Risley prism pair;
a second actuator for said second Risley prism pair, wherein said second actuator adjusts a second deflection angle of said second Risley prism pair so that second Risley prism pair aligns said second light beam to be incident on a first outside prism face of said first Risley prism pair, thereby forming an aligned optical path between said input optical fiber and said output optical fiber wherein a signal light beam is transmitted over said aligned optical path between said input optical fiber and said output optical fiber.

32. The optical communication system of claim 31 further comprising:
a second input optical fiber connected to said optical switch;
a second output optical fiber connected to said optical switch wherein:
said input optical fiber is connected as a working fiber;
said second input optical fiber is connected as a protection fiber;
said output optical fiber is connected as a working fiber;
said second output optical fiber is connected as a protection fiber; and
said optical switch is connected for use as a protection switch.

33. The optical communication system of claim 31 further comprising:
a second input optical fiber connected to said optical switch;
a second output optical fiber connected to said optical switch wherein:
said input optical fiber is connected as a working fiber;
said second input optical fiber is connected as an add fiber;
said output optical fiber is connected as a working fiber;
said second output optical fiber is connected as a drop fiber; and
said optical switch is connected for use as an add/drop module.

34. The optical communication system of claim 31 wherein:
said input optical fiber is connected as a working fiber;
said output optical fiber is connected as a working fiber; and
said optical switch is connected for use as a non-blocking cross-connect switch.

35. An optical communication system comprising:
a plurality of nodes;
at least one link between two nodes in said plurality of nodes;
a first node in said plurality of nodes, said first node comprising:
an input optical fiber transmitting a first light beam;
a first Risley prism pair disposed in an optical path between said input optical fiber and said at least one link;
a first actuator for said first Risley prism pair, wherein said first actuator adjusts a first deflection angle of said first Risley prism pair; and
a second node in said plurality of nodes, said second node comprising:
an output optical fiber transmitting a second light beam;
a second Risley prism pair disposed in said optical path between said first Risley prism pair and said output optical fiber; wherein said first actuator adjusts said first deflection angle so that said first Risley prism pair steers said first light beam to be incident on a second outside prism face of said second Risley prism pair;
a second actuator for said second Risley prism pair, wherein said second actuator adjusts a second deflection angle of said second Risley prism pair so that said second Risley prism pair aligns said second light beam to be incident on a first outside prism face of said first Risley prism pair, thereby forming an aligned optical path between said input optical fiber and said output optical fiber wherein a signal light beam is transmitted over said aligned optical path so that said first node optically communicates over said at least one link with said second node.

36. The optical communication system of claim 35 wherein:
said first node comprises a lasercom terminal; and
said second node comprises a lasercom terminal.

37. The optical communication system of claim 35 wherein:
said first node comprises a ground lasercom terminal; and
said second node comprises a satellite lasercom terminal.

38. The optical communication system of claim 35, wherein said first node further comprises a controller that receives feedback signals from said first actuator and provides control signals to said first actuator.

39. The optical communication system of claim 38 wherein said first actuator includes a position sensor that senses a position of a prism of said first Risley prism pair and provides a feedback signal to said controller.

40. The optical communication system of claim 35 wherein an optical angle of said first Risley prism pair is at least 1.1 degrees.

41. An actuator for a Risley prism pair, said actuator comprising:
an optical path;
a first drive motor connected to a first Risley prism wherein a first drive motor rotation is transmitted to a first rotation of said first Risley prism about a central axis without blocking said optical path;
a second drive motor connected to a second Risley prism wherein a second drive motor rotation is transmitted to a second rotation of said second Risley prism about said central axis without blocking said optical path;
said second rotation and said first rotation are independent; and
an outside diameter of said actuator with respect to said central axis is less than 2.5 cm.

42. The actuator of claim 41 wherein said first rotation and said second rotation adjust a deflection angle of said Risley prism pair.

43. The actuator of claim 41 wherein an outside diameter of said actuator with respect to said central axis is less than 2.5 cm and greater than 1.0 cm.

44. The actuator of claim 41, further comprising a position sensor that senses an angle of rotation of said first prism of said Risley prism pair and provides a feedback signal containing information about said angle of rotation.

45. The actuator of claim 41, further comprising:
a first drive that connects said first drive motor to said first Risley prism and transmits said first drive motor rotation to said first rotation of said first Risley prism; and
a second drive that connects said second drive motor to said second Risley prism and transmits said second drive motor rotation to said second rotation of said second Risley prism.

46. The actuator of claim 45 wherein said first drive is a reduction drive.

47. The actuator of claim 45 wherein said first drive is a direct drive.

48. The actuator of claim 45 wherein said second drive is a reduction drive.

49. The actuator of claim 45 wherein said second drive is a direct drive.

50. The actuator of claim 45 wherein said first drive is a friction drive.

51. The actuator of claim 45 wherein said first drive is a gear drive.

52. The actuator of claim 45 wherein said second drive is a friction drive.

53. The actuator of claim 45 wherein said second drive is a gear drive.

54. The actuator of claim 41, further comprising:
a first connecting rod that connects said first drive motor to said first Risley prism and transmits said first drive motor rotation to said first rotation of said first Risley prism; and
a second connecting rod that connects said second drive motor to said second Risley prism and transmits said second drive motor rotation to said second rotation of said second Risley prism.

55. The actuator of claim 54 wherein said first drive motor is positioned in line with said central axis, and said second drive motor is positioned in line with said central axis.

56. The actuator of claim 54, further comprising:
a first crank that connects said first drive motor to said first connecting rod and transmits said first drive motor rotation to said first connecting rod;
a first prism holder that connects said first connecting rod to said first prism and transmits said first drive motor rotation to said first prism;
a second crank that connects said second drive motor to said second connecting rod and transmits said second drive motor rotation to said second connecting rod; and
a second prism holder that connects said second connecting rod to said second prism and transmits said second drive motor rotation to said second prism;

57. The actuator of claim 41, wherein:
said first drive motor is a hollow-shaft motor comprising a first hollow shaft that:
connects said first drive motor to said first Risley prism and transmits said first drive motor rotation to said first rotation of said first Risley prism, and
surrounds said optical path; and
said second drive motor is a hollow-shaft motor comprising a second hollow shaft that:
connects said second drive motor to said second Risley prism and transmits said second drive motor rotation to said second rotation of said second Risley prism, and
surrounds said optical path;

58. The actuator of claim 57 wherein said first drive motor is positioned in line with said central axis, and said second drive motor is positioned in line with said central axis.

59. The actuator of claim 57 wherein said first drive motor is a frameless motor, and said second drive motor is a frameless motor.

60. The actuator of claim 41 wherein said first drive motor is an electrical stepper motor, and said second drive motor is an electrical stepper motor.

61. The actuator of claim 41 wherein said first drive motor is a DC electrical motor, and said second drive motor is a DC electrical motor.

62. A method for optical beam alignment comprising steps of:
inserting a first light beam into a first Risley prism pair;
inserting a second light beam into a second Risley prism pair;
adjusting said first Risley prism pair to steer said first light beam to be incident on a second outside prism face of said second Risley prism pair; and
adjusting said second Risley prism pair to deflect said second light beam to be incident on a first outside prism face of said first Risley prism pair; thereby forming an aligned optical path.

63. The method of claim 62 further comprising a step of:
transmitting a signal light beam over said aligned optical path through said first Risley prism pair and said second Risley prism pair.

64. The method of claim 62 further comprising a step of:
performing optical switching by transmitting a signal light beam on an optical path through said first Risley prism pair and said second Risley prism pair.

65. The method of claim 62 further comprising a step of:
performing free space optical communication by transmitting a signal light beam on an optical path through said first Risley prism pair and said second Risley prism pair.

66. The method of claim 62 wherein:
said adjusting step comprises controlling said first Risley prism pair using a first feedback signal from a first position sensor to a controller and providing a first control signal to a first actuator for said first Risley prism pair; and
said forming step comprises controlling said second Risley prism pair using a second feedback signal from a second position sensor to said controller and providing a second control signal to a second actuator for said second Risley prism pair.

67. A method for optically switching light beams in an optical switch, comprising steps of:
selecting an input optical fiber and an output optical fiber to be optically connected to each other;
inserting a first light beam in said input optical fiber to be transmitted through a first Risley prism pair;
inserting a second light beam in said output optical fiber to be transmitted through a second Risley prism pair;
adjusting said first Risley prism pair to steer said first light beam to be incident on a second outside prism face of said second Risley prism pair; and
adjusting said second Risley prism pair to align said second light beam to be incident on a first outside prism face of said first Risley prism pair; thereby forming an aligned optical path between said input optical fiber and said output optical fiber.

68. The method of claim 67 further comprising a step of:
transmitting a signal light beam between said input optical fiber and said output optical fiber along said aligned optical path through said first Risley prism pair and said second Risley prism pair, thereby optically connecting said input optical fiber with said output optical fiber.

69. The method of claim 67 wherein:
said step of adjusting said first Risley prism pair comprises controlling said first Risley prism pair using feedback between a controller and a first actuator for said first Risley prism pair; and
said step of adjusting said second Risley prism pair comprises controlling said second Risley prism pair using feedback between said controller and a second actuator for said second Risley prism pair

70. The method of claim 67 further comprising a step of:
connecting said optical switch in a switching network comprising a plurality of working fibers and a plurality of protection fibers, said optical switch connected for use as a protection switch;
wherein said selecting step comprises:
selecting said input optical fiber from one of said plurality of working fibers and said plurality of protection fibers and
selecting said output optical fiber from one of said plurality of working fibers and said plurality of protection fibers.

71. The method of claim 67 further comprising a step of:
connecting said optical switch in a switching network comprising a plurality of working fibers, a plurality of add fibers, and a plurality of drop fibers, said optical switch connected for use as an add/drop module;
wherein said selecting step comprises:
selecting said input optical fiber from one of said plurality of working fibers and said plurality of add fibers and
selecting said output optical fiber from one of said plurality of working fibers and said plurality of drop fibers.

72. The method of claim 67 further comprising a step of:
connecting said optical switch in a switching network comprising a plurality of working fibers, said optical switch connected for use as a non-blocking cross-connect switch;
wherein said selecting step comprises:
selecting said input optical fiber from said plurality of working fibers and
selecting said output optical fiber from said plurality of working fibers.
